(19) United States
(12) Patent Application Publication
(10) Pub. No.: US 2018/0191216 A1
(43) Pub. Date: Jul. 5, 2018

(54) ROTOR FOR ELECTRIC MACHINE AND ELECTRIC MACHINE COMPRISING THE SAME

(71) Applicant: ABB Schweiz AG, Baden (CH)

(72) Inventors: Jukka MALMBERG, Helsinki (FI); Carl-Mikael HEIKEL, Espoo (FI); Tero KOIVISTO, Vantaa (FI); Wille HALMESMÄKI, Helsinki (FI); Zlatko KOLONDJOVSKI, Vantaa (FI)

(21) Appl. No.: 15/740,716

(22) PCT Filed: Jun. 29, 2016
(86) PCT No.: PCT/EP2016/065165

§ 371 Date: Dec. 28, 2017

(30) Foreign Application Priority Data
Jun. 30, 2015 (CN) 201510393646.5

(51) Int. Cl. H02K 1/32; H02K 1/26

(52) U.S. Cl. CPC H02K 1/32; H02K 17/00; H02K 1/26

(57) ABSTRACT

A rotor for an electric machine, the rotor including a rotor core having an outer portion and an inner portion located closer to the rotation axis of the rotor core than the outer portion. The outer portion is connected to the inner portion through a plurality of spokes, and the rotor core is adapted to be connected to a rotor shaft by a shrink fit. Each of the spokes includes at least one skew portion extending in a spoke angle relative to a radial direction of the rotor core, the spoke angle being greater than 30°.

### FIELD OF THE INVENTION

The invention relates to a rotor for an electric machine.

A known rotor for an induction machine comprises a rotor core having an outer portion and an inner portion located closer to the rotation axis of the rotor core than the outer portion, the outer portion being connected to the inner portion through a plurality of spokes, each one of which extends in a radial direction. The spokes are spaced apart from each other in circumferential direction such that there is an axial cooling channel between each two adjacent spokes. Said known rotor further comprises a rotor shaft connected to the rotor core by a shrink fit.

One of the disadvantages associated with the above rotor is that the shrink fit between the rotor core and the rotor shaft loosens substantially when the rotor heats during use. An outer surface of an induction machine rotor heats more during operating conditions than an outer surface of a rotor of a permanent magnet machine, for example. Depending on the design, a shrink fit between a rotor core and a rotor shaft of an induction machine may be able to transfer only 30% of torque in operating temperature compared with a situation where the rotor is cold. Increasing a tightness of a shrink fit is likely to incur curving of the rotor shaft. Therefore it is difficult to provide a practical shrink fit between the rotor core and the rotor shaft.

### BRIEF DESCRIPTION OF THE INVENTION

An object of the present invention is to provide a rotor for an electric machine and an electric machine comprising the rotor so as to alleviate the above disadvantages. The objects of the invention are achieved by a rotor and an electric machine described in the following.

The invention is based on the idea of redesigning spokes connecting an outer portion and an inner portion of a rotor core such that radial transfer of forces between the outer portion and the inner portion of the rotor core is reduced. Each of the redesigned spokes is a flexible spoke comprising a skew portion extending in a non-radial direction. The skew portions of the spokes make geometry of the rotor core more flexible thereby reducing transfer of forces in radial direction between the outer portion and the inner portion of the rotor core. The skew portions allow each spoke to deform when a surface of a rotor heats more than inner parts of the rotor.

In an embodiment a torque transfer capability of a shrink fit between a rotor core and a rotor shaft is further improved by providing an outer portion of the rotor core with a plurality of small cooling channels such that cooling of the outer portion of the rotor core is improved. The plurality of small cooling channels increase total cooling area of the cooling channels compared with fewer large cooling channels. This decreases a temperature difference between the outer portion and the inner portion of the rotor core thereby improving the tightness of the shrink fit between the rotor core and the rotor shaft in operating conditions. Further, providing an outer portion of a rotor core with a plurality of small cooling channels improves rotational symmetry of the rotor core and enables symmetrical distribution of magnetic flux even when the cooling channels are located close to rotor bars.

An advantage of the invention is that contact pressure at a shrink fit between a rotor core and a rotor shaft is less affected by heating of an outer surface of the rotor core than in the case of the prior art design with radial spokes. In a rotor according to the invention a radial outwards directed force exerted by an outer portion of a rotor core on an inner portion of the rotor core is in operating conditions smaller than in the known rotor. Therefore the shrink fit maintains its torque transfer capability in operating conditions better than the shrink fit of the known rotor with radial spokes. This means that a less tight shrink fit can be manufactured without fear of the shrink fit disengaging in operating conditions.

### BRIEF DESCRIPTION OF THE DRAWINGS

In the following the invention will be described in greater detail by means of preferred embodiments with reference to the attached drawings, in which

FIG. 1 shows a rotor core according to an embodiment of the invention as seen from an axial direction of the rotor core;

FIG. 2 shows an enlargement of a portion of the rotor core of FIG. 1;

FIGS. 3 to 9 show rotor cores according to alternative embodiments of the invention;

FIG. 10 shows a rotor core comprising a plurality of rotor sheets stacked in an axial direction;

FIG. 11 shows a rotor comprising the rotor core of FIG. 10 and a rotor shaft connected to the rotor core by a shrink fit; and

FIG. 12 shows a rotor core according to an embodiment of the invention in which each spoke is connected to an outer portion of the rotor core through two outer branches, and to an inner portion of the rotor core through an inner branch.

### DETAILED DESCRIPTION OF THE INVENTION

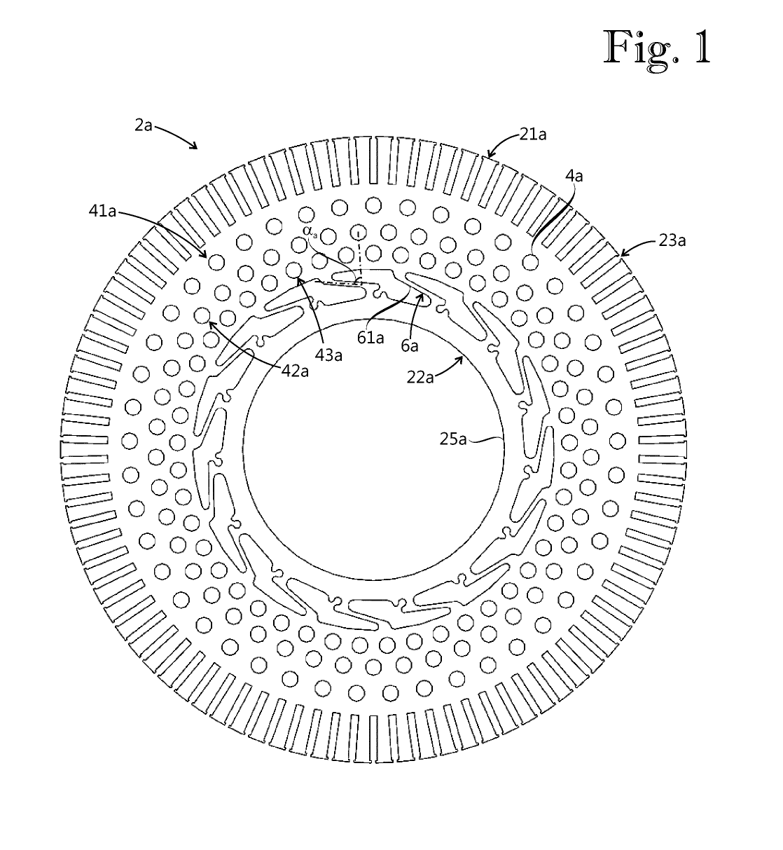

FIG. 1 shows a rotor core 2a having an outer portion 21a and an inner portion 22a located closer to the rotation axis of the rotor core 2a than the outer portion 21a. The outer portion 21a is connected to the inner portion 22a through a plurality of spokes 6a. The outer portion 21a comprises a plurality of cooling channels 4a, each of which extends through the rotor core 2a in axial direction and is adapted for a flow of a cooling medium such as air. The inner portion 22a comprises a central aperture 25a adapted to receive a rotor shaft for connecting the rotor core 2a to the rotor shaft by a shrink fit.

Shrink-fitting is a well-known technique in which an interference fit is achieved by a relative size change after assembly. A shrink fit between a rotor core and a rotor shaft may be achieved by heating the rotor core before assembly and allowing it to return to the ambient temperature after assembly. Such a shrink-fitting exploits thermal expansion.

Each of the spokes 6a comprises a skew portion 61a extending in a spoke angle αₐ relative to a radial direction of the rotor core 2a. The spoke angle αₐ is measured relative to a centre line of the spoke 6a. The spoke angle αₐ is approximately 80°, depending on the location where the spoke angle is measured. The spoke angle αₐ is in its maximum at an inner end of the spoke 6a. The inner end of the spoke 6a is the end which is located adjacent the inner portion 22a of the rotor core 2a. An outer end of the spoke 6a is the end which is located adjacent the outer portion 21a of the rotor core 2a.

A length of a skew portion affects flexibility of a corresponding spoke. In FIG. 1 a length of a skew portion 61a is roughly 0.07 times a diameter of the rotor core 2a. In alternative embodiments a length of a skew portion is in a range of 0.04 to 0.15 times a diameter of the rotor core. In some embodiments a spoke comprises more than one skew portion such that a total length of a flexible portion of the spoke is a sum of the lengths of the more than one skew portion. An example of such an embodiment is depicted in FIG. 6.

During operation of an electric machine comprising the rotor core 2a the outer portion 21a of the rotor core 2a heats up and expands. However, only a small outwards directed force is exerted on the inner portion 22a of the rotor core 2a through the plurality of spokes 6a. Due to the form of the spokes 6a they have a good torque transfer capability between the outer portion 21a of the rotor core 2a and the inner portion 22a of the rotor core 2a while they transfers only little force in the radial direction. The spokes 6a provide a very flexible connection in the radial direction between the outer portion 21a of the rotor core 2a and the inner portion 22a of the rotor core 2a. Due to the flexible spokes 6a heat expansion of the outer portion 21a of the rotor core 2a affects only little a torque transfer capability of a shrink fit between the rotor core 2a and a rotor shaft.

A width of a spoke is chosen such that the spoke has desired flexibility so that thermal expansion of an outer portion of the rotor core does not affect excessively on the torque transfer capability of the shrink fit between the rotor core and the rotor shaft. A number of the spokes is chosen such that the plurality of spokes is able to transfer sufficiently torque between the outer portion of the rotor core and the inner portion of the rotor core.

The plurality of cooling channels comprises a first group 41a of cooling channels at a first distance from a rotation axis of the rotor core 2a, a second group 42a of cooling channels at a second distance from the rotation axis of the rotor core 2a, and a third group 43a of cooling channels at a third distance from the rotation axis of the rotor core 2a. Each group of cooling channels is located at a different distance from the rotation axis of the rotor core 2a than the rest of the cooling channel groups. The first group 41a of cooling channels is the outermost group, the third group 43a of cooling channels is the innermost group, and the second group 42a of cooling channels is located between the first group 41a and the third group 43a in radial direction.

A cross section of each of the plurality of cooling channels 4a is substantially circular, and a diameter of each of the plurality of cooling channels 4a is less than 0.03 times a diameter of the rotor core 2a. In alternative embodiments a diameter of each of the plurality of cooling channels is 0.06 times a diameter of the rotor core or less. Further, in alternative embodiments cross section of cooling channels may have a shape different than circular, such as an oval or a polygonal shape. Also, in some embodiments separate cooling channels are omitted, and cooling of a rotor core is realized by a flow of a cooling medium through gaps between the spokes. In embodiments which do comprise separate cooling channels, a number of cooling channels and a number of cooling channel groups can vary. Also, one group of cooling channels may have different size cooling channels than another group of cooling channels.

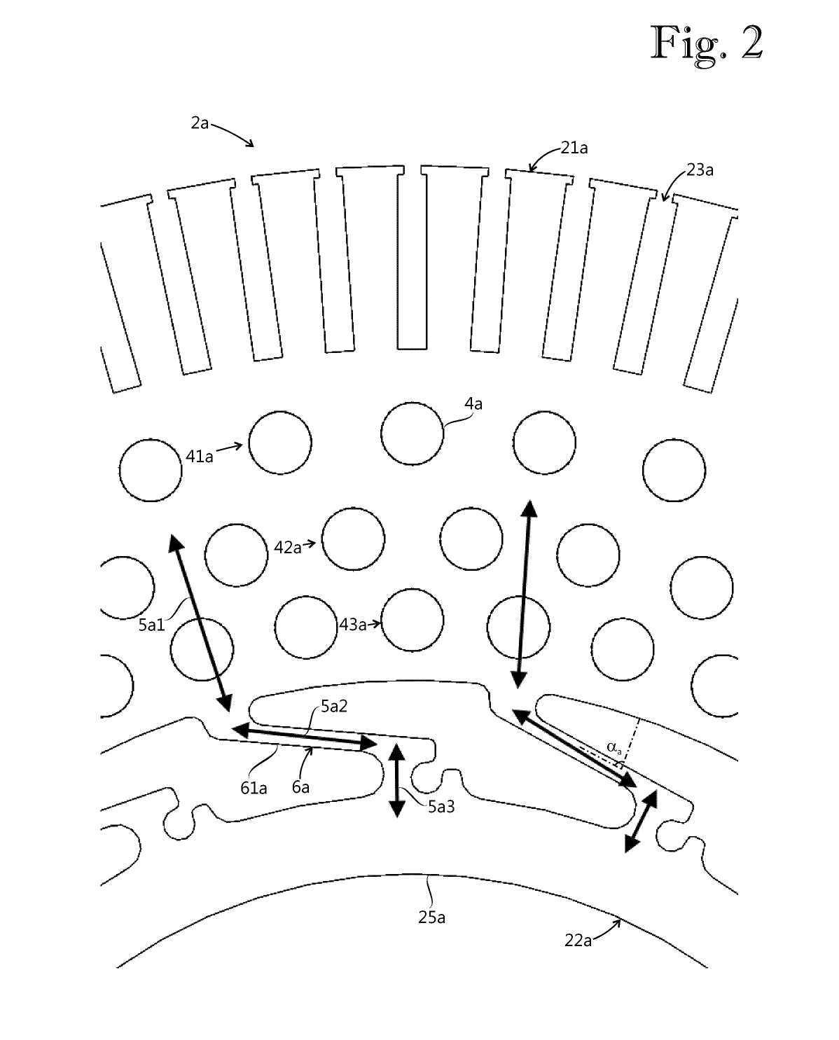

FIG. 2 shows an enlargement of a portion of the rotor core 2a. FIG. 2 is provided with arrows 5a1 to 5a3 depicting directions of forces induced by temperature difference between the outer portion 21a and the inner portion 22a of the rotor core 2a. FIG. 2 shows that a force present in a skew portion 61a extends in a direction parallel to the skew portion 61a. The force is almost tangential and therefore it rotates the outer portion 21a slightly relative to the inner portion 22a.

The rotor core 2a comprises a plurality of rotor slots 23a on periphery thereof. Each rotor slot 23a is adapted to receive a corresponding rotor bar (not depicted).

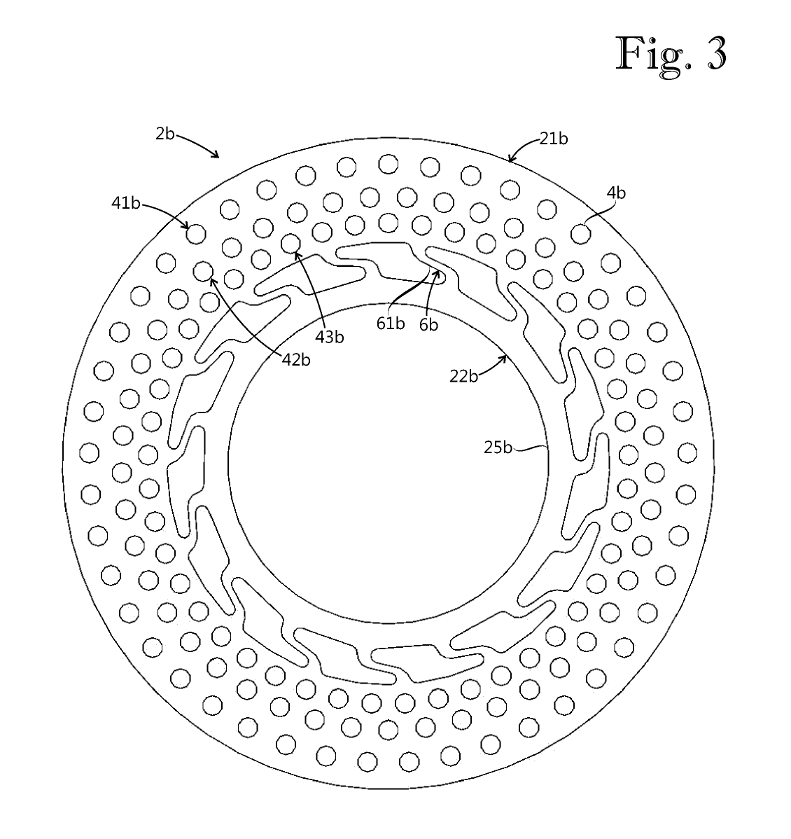

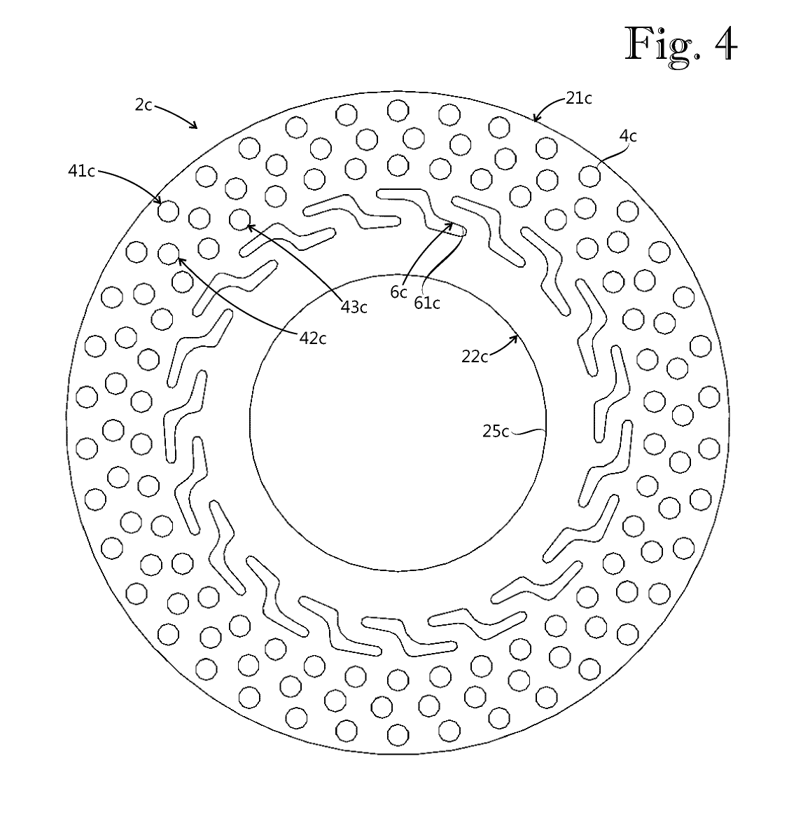

FIGS. 3 to 9 show rotor cores according to alternative embodiments of the invention. Reference signs of FIGS. 3 to 9 correspond to those of FIG. 1 such that a particular feature is denoted in these figures with reference signs having a common numeric part in the beginning of reference sign. Each reference sign further comprises a letter identifying the embodiment in question. Reference signs of FIG. 1 comprise letter “a”, and the reference signs of FIGS. 3 to 9 comprise letters “b” to “h”, respectively.

In FIGS. 3 to 9 an outer surface of each rotor core is depicted as a smooth circular surface. However, each rotor core design of FIGS. 3 to 9 can be provided with rotor slots similar to those depicted in FIGS. 1 and 2. Further, all rotor core designs of FIGS. 1 to 9 can be used in many types of electric machines, and not only in induction machines. An outer surface of a rotor core is shaped according to requirements of a machine type in question while the design of spokes and inner portion of the rotor core may remain the same.

FIGS. 1 to 9 show that a form and a size of a spoke vary in different embodiments, and so does the spoke angle α. In general case the spoke angle α is greater than 30°.

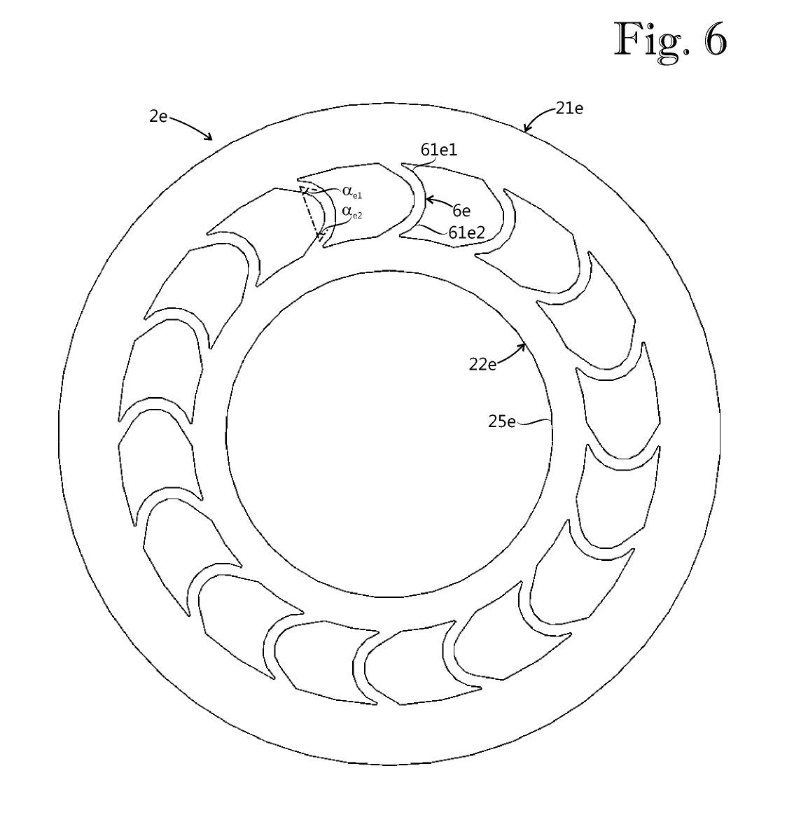

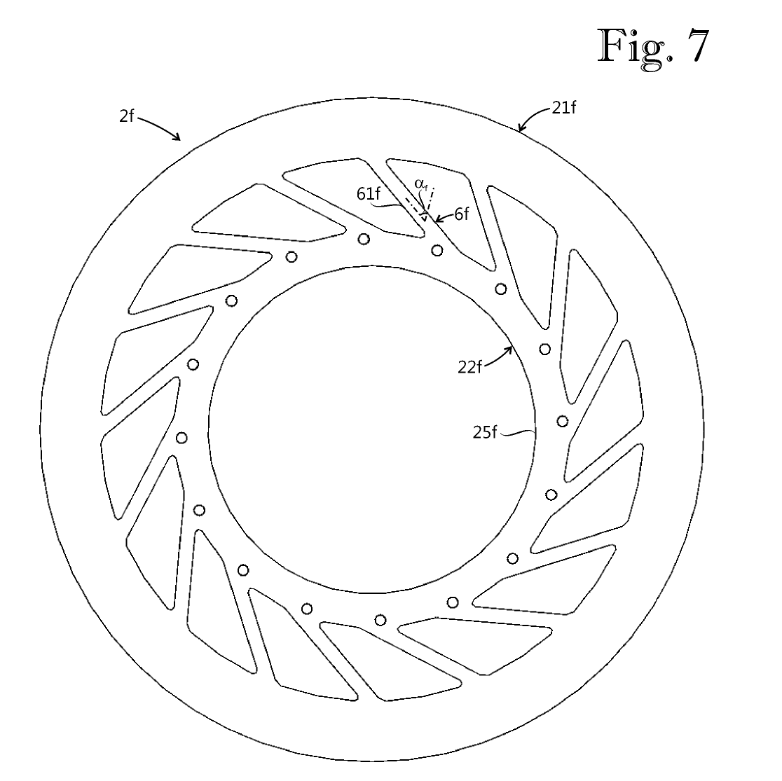

A spoke can be a straight or a curved element. Also, a spoke can have both straight and curved portions. In the embodiment of FIG. 1 each skew portion 61a extends linearly. In the embodiment of FIG. 7 the entire spoke 6f extends linearly. In the embodiment of FIG. 6 each spoke 6e is a curvilinear member having a wide U-shaped form connecting the outer portion 21e and the inner portion 22e of the rotor core 2e. Accordingly skew portions 61e1 and 61e2 are also curvilinear members and spoke angles αₑ₁ and αₑ₂ are not constant throughout the skew portions.

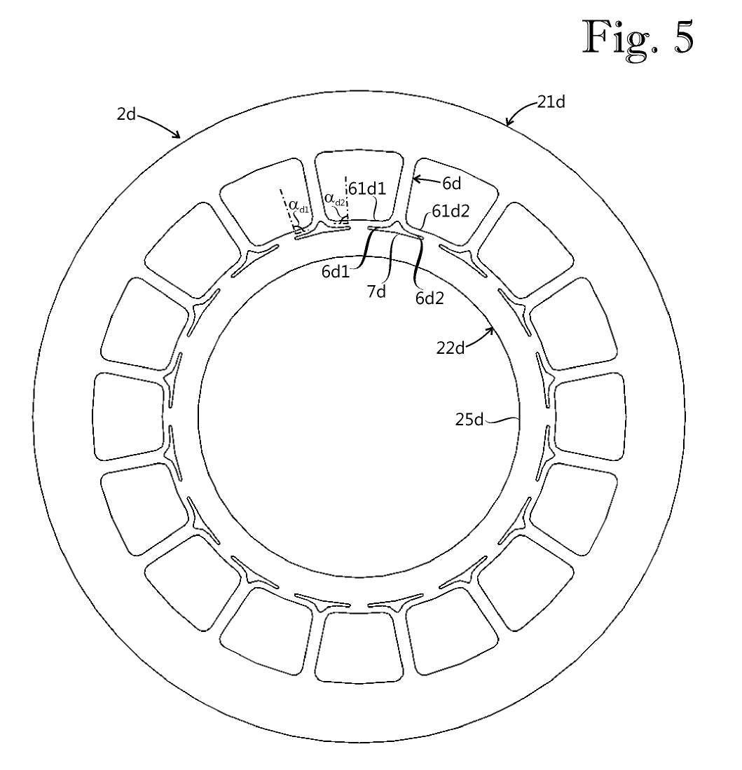

In general case each of the spokes connecting an inner portion and an outer portion of a rotor core comprises at least one skew portion extending in a spoke angle relative to a radial direction of the rotor core. In embodiment of FIG. 5 each spoke 6d has two branches 6d1 and 6d2 adjacent the inner portion 22d of the rotor core 2d. The branches 6d1 and 6d2 are mirror images of each other with relation to radial direction of the rotor core 2d. The branch 6d1 comprises a skew portion 61d1 extending in a spoke angle α_{d1} relative to a radial direction of the rotor core 2d, the spoke angle α_{d1} being approximately 90° in a laterally outer portion of the branch 6d1. Herein the laterally outer portion is the portion of the branch 6d1 that is located furthest from the radial centre line of the spoke 6d. Due to the symmetry of the branches, the branch 6d2 comprises a skew portion 61d2 extending in a spoke angle α_{d2} relative to a radial direction of the rotor core 2d, the spoke angle α_{d2} being approximately 90° in a laterally outer portion of the branch 6d2.

In FIG. 5, the branches 6d1 and 6d2 form a cavity 7d between the inner portion 22d of the rotor core 2d and the spoke 6d. The cavity 7d is symmetrical with relation to radial direction of the rotor core 2d. A radial dimension of the cavity 7d has its maximum at the symmetry axis of the cavity 7d, and the radial dimension of the cavity 7d decreases outwards from the symmetry axis. Herein the radial dimension refers to dimension parallel to the radial direction of the rotor core.

The cavity 7d provides flexibility between the inner portion 22d of the rotor core 2d and the spoke 6d. The cavity 7d is adapted to change its size and shape as a response to radial forces between the outer portion 21d and the inner portion 22d of the rotor core 2d. Therefore also the spoke 6d is adapted to change its shape as a response to radial forces between the outer portion 21d and the inner portion 22d of the rotor core 2d. This makes the spoke 6d a flexible member whose capability to transfer forces in radial direction is weak. Accordingly a temperature difference between the outer portion 21d and the inner portion 22d of the rotor core 2d does not substantially affect the size of the central aperture 25d of the rotor core 2d.

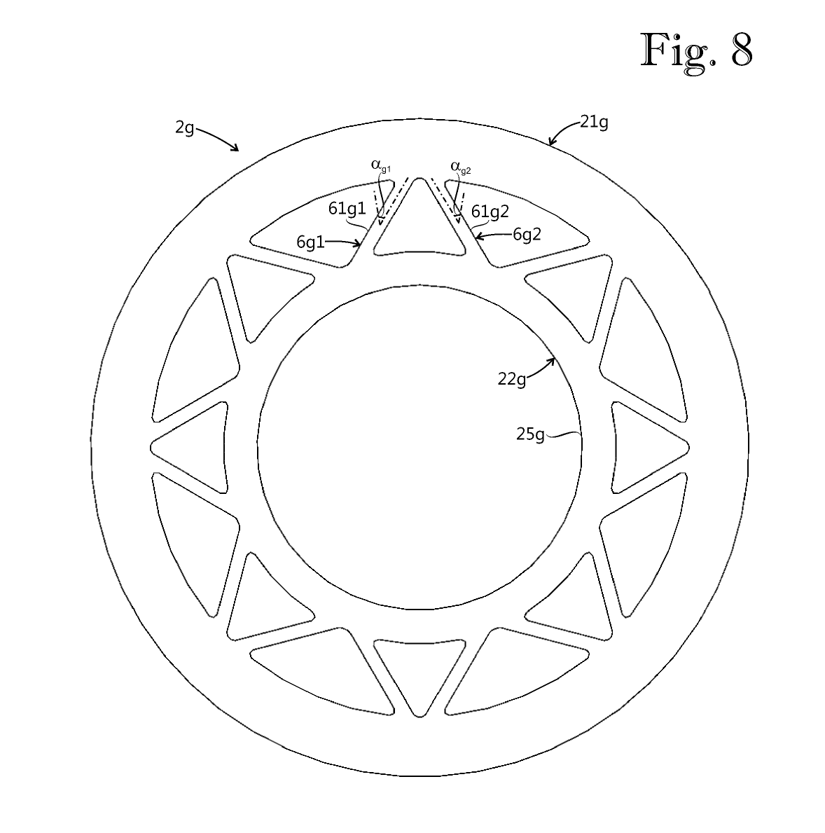

The rotor core 2g of FIG. 8 has two types of spokes such that each first type spoke 6g1 extends in a spoke angle α_{g1} relative to a radial direction of the rotor core 2g, and each second type spoke 6g2 extends in a spoke angle α_{g2} relative to a radial direction of the rotor core 2g. The spoke angles α_{g1} and α_{g2} have identical absolute values but opposite signs such that the first type spokes 6g1 and the second type spokes 6g2 are mirror images of each other with relation to radial direction of the rotor core 2g.

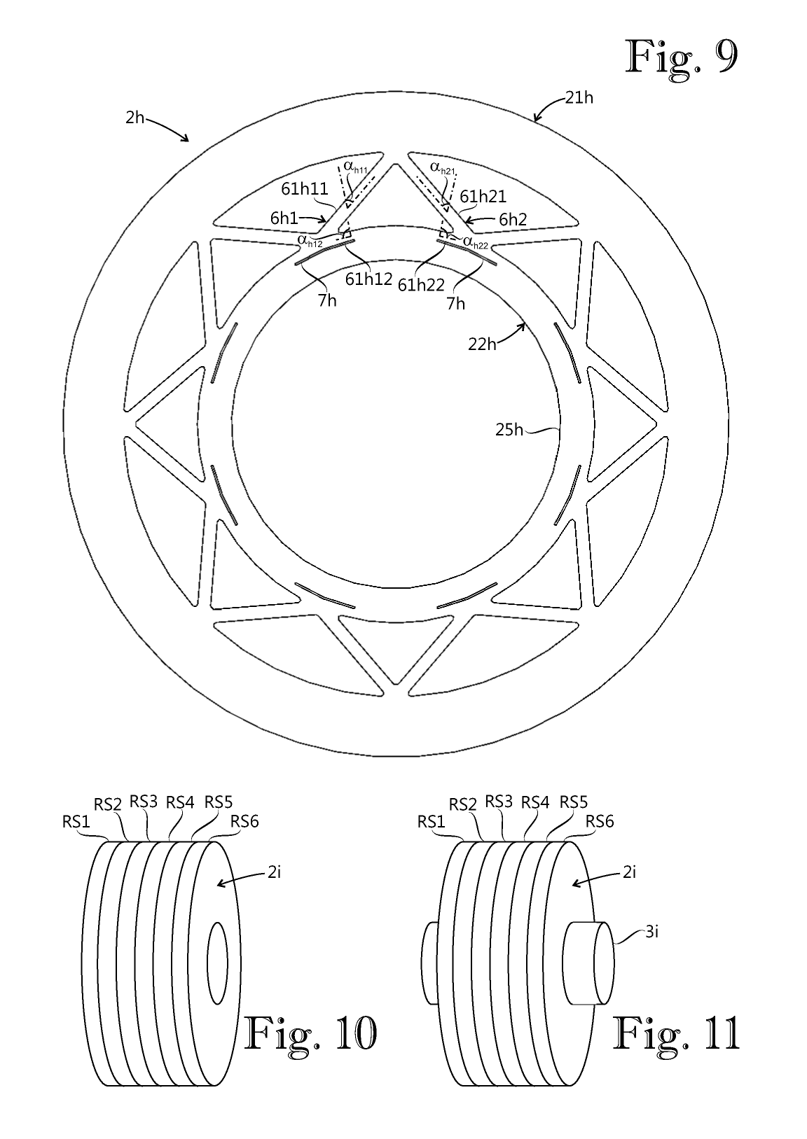

FIG. 9 shows a rotor core 2h whose outer portion 21h is connected to the inner portion 22h through a plurality of spokes 6h1 and 6h2. Each spoke 6h1 comprises an outer skew portion 61h11 and an inner skew portion 61h12. The outer skew portion 61h11 is located adjacent the outer portion 21h of the rotor core 2h, and the inner skew portion 61h12 is located adjacent the inner portion 22h of the rotor core 2h.

The outer skew portion 61h11 extends in a spoke angle αₕ₁₁ relative to a radial direction of the rotor core 2h. The spoke angle αₕ₁₁ is approximately 60°. The inner skew portion 61h12 extends in a spoke angle αₕ₁₂ relative to a radial direction of the rotor core 2h. The spoke angle αₕ₁₂ is approximately 90°. The spoke angles αₕ₁₁ and αₕ₁₂ have opposite signs.

The spokes 6h1 and 6h2 are mirror images of each other with relation to radial direction of the rotor core 2h. Each spoke 6h1 is connected to an adjacent spoke 6h2 through its middle portion located between the outer skew portion 61h11 and the inner skew portion 61h12. Further, each spoke 6h1 is connected to another adjacent spoke 6h2 through its outer portion located adjacent the outer portion 21h of the rotor core 2h.

There is a cavity 7h between the inner portion 22h of the rotor core 2h and the connected inner skew portions 61h12 and 61h22. The cavity 7h is symmetrical with relation to radial direction of the rotor core 2h. The cavity 7h extends in a substantially tangential direction. Herein the tangential direction refers to the tangential direction of the rotor core. A radial dimension of the cavity 7h is substantially constant throughout the cavity 7h. The cavity 7h is adapted to change its size and shape as a response to radial forces between the outer portion 21h and the inner portion 22h of the rotor core 2h.

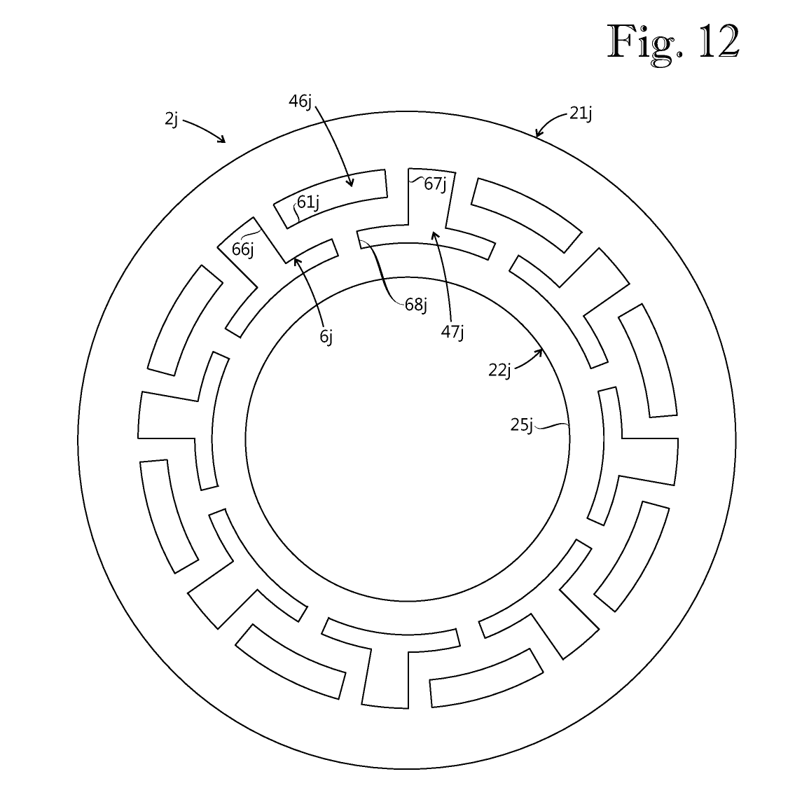

FIG. 12 shows a rotor core 2j having an outer portion 21j and an inner portion 22j located closer to the rotation axis of the rotor core 2j than the outer portion 21j. The outer portion 21j is connected to the inner portion 22j through a plurality of spokes 6j which provide a very flexible connection in the radial direction between the outer portion 21j of the rotor core 2j and the inner portion 22j of the rotor core 2j. Due to the flexible spokes 6j heat expansion of the outer portion 21j of the rotor core 2j affects only little a torque transfer capability of a shrink fit between the rotor core 2j and a rotor shaft. The inner portion 22j comprises a central aperture 25j adapted to receive a rotor shaft for connecting the rotor core 2j to the rotor shaft by a shrink fit.

Each spoke 6j is connected to the outer portion 21j of the rotor core 2j through two outer branches denoted with reference signs 66j and 67j, and to the inner portion 22j of the rotor core 2j through an inner branch 68j. The outer branches 66j and 67j are located at a distance from each other in a circumferential direction of the rotor core 2j. Each spoke 6j comprises a skew portion 61j connected to the two outer branches 66j and 67j and to the inner branch 68j. The spoke 6j is symmetric with respect to a centre line of the inner branch 68j. A spoke angle of the skew portion 61j is 90°.

Each of the outer branches 66j and 67j extend substantially in radial direction. Also the inner branch 68j of the spoke 6j extends substantially in radial direction. The skew portion 61j extends substantially in tangential direction. The skew portion 61j is a curved part a centre line of which extends substantially in tangential direction throughout the skew portion 61j. In an alternative embodiment a skew portion of a spoke extends linearly between two outer branches, and a centre line of the skew portion is tangential at an inner branch of the spoke.

The skew portion 61j is located closer to the inner portion 22j of the rotor core 2j than the outer portion 21j of the rotor core 2j. This means that outer branches 66j and 67j of the spoke 6j are longer than the inner branch 68j of the spoke 6j. Further, distance between the skew portion 61j and the outer portion 21j of the rotor core 2j is greater than distance between the skew portion 61j and the inner portion 22j of the rotor core 2j.

The skew portion 61j, the two outer branches 66j and 67j, and the outer portion 21j of the rotor core 2j define an outer intermediate cooling channel 46j extending through the rotor core 2j in axial direction and being adapted for a flow of a cooling medium. The outer intermediate cooling channel 46j is located between the outer branches 66j and 67j of the spoke 6j when seen in a circumferential direction of the rotor core 2j. Adjacent spokes 6j define, together with the outer portion 21j and the inner portion 22j of the rotor core 2j, an inner intermediate cooling channel 47j extending through the rotor core 2j in axial direction and being adapted for a flow of a cooling medium.

The rotor core 2j does not comprise cooling channels located in the outer portion 21j of the rotor core 2j. However, it is possible to modify the rotor core 2j by introducing cooling channels to the outer portion 21j of the rotor core 2j. In an embodiment a rotor core is provided with spokes of FIG. 12 between inner and outer portion of the rotor core, and a plurality of cooling channels of FIG. 1 located in the outer portion of the rotor core.

In FIG. 12 an outer surface of the rotor core 2j is depicted as a smooth circular surface. However, the rotor core of FIG. 12 can be provided with rotor slots similar to those depicted in FIGS. 1 and 2. The rotor core design of FIG. 12 can be used in many types of electric machines. An outer surface of a rotor core is shaped according to requirements of a machine type in question while the design of spokes and inner portion of the rotor core may remain the same.

Each of the rotor cores of FIGS. 1 to 9 and 12 may be used in an electric machine of an azimuth thruster of a ship. In an embodiment a nominal power of an electric machine comprising a rotor according to the invention is greater than or equal to 100 kW.

In an embodiment a rotor core according to the invention comprises a plurality of rotor sheets stacked in an axial direction. Any one of the rotor cores of FIGS. 1 to 9 and 12 may be constructed as such a rotor core.

A principle structure of a rotor core comprising a plurality of rotor sheets stacked in an axial direction is depicted in FIG. 10. FIG. 11 shows a rotor comprising the rotor core 2i of FIG. 10 and a rotor shaft 3i connected to the rotor core 2i by a shrink fit. The rotor core 2i comprises rotor sheets RS1, RS2, RS3, RS4, RS5 and RS6 stacked in an axial direction. Each of the rotor sheets RS1-RS6 is manufactured by a punching process from a metal plate. Each of the rotor sheets RS1-RS6 is identical with the rest of the rotor sheets.

It will be obvious to a person skilled in the art that the inventive concept can be implemented in various ways. The invention and its embodiments are not limited to the examples described above but may vary within the scope of the claims.

1. A rotor for an electric machine, the rotor comprising:
a rotor core having an outer portion and an inner portion located closer to the rotation axis of the rotor core than the outer portion, the outer portion being connected to the inner portion through a plurality of spokes, and the rotor core being adapted to be connected to a rotor shaft by a shrink fit, each of the spokes comprises at least one skew portion extending in a spoke angle relative to a radial direction of the rotor core, each of the spokes is connected to the outer portion of the rotor core through two outer branches, and to the inner portion of the rotor core through an inner branch, each of the spokes comprises a skew portion connected to the two outer branches and to the inner branch, wherein the outer branches are located at a distance from each other in a circumferential direction of the rotor core, the skew portion extends substantially in tangential direction, and each outer branch and inner branch extend substantially in radial direction, each of the spokes is symmetric with respect to a centre line of the inner branch, and the spokes are separate elements without contact with each other.

2. The rotor according to claim 1, wherein the rotor comprises a plurality of cooling channels located in the outer portion of the rotor core, each of the plurality of cooling channels extending through the rotor core in axial direction and being adapted for a flow of a cooling medium.

3. The rotor according to claim 2, wherein the plurality of cooling channels comprises a first group of cooling channels at a first distance from a rotation axis of the rotor core and a second group of cooling channels at a second distance from the rotation axis of the rotor core, and a diameter of each of the plurality of cooling channels is 0.06 times a diameter of the rotor core or less.

4. The rotor according to claim 1, wherein the rotor is a rotor for an induction machine.

5. The rotor according to claim 1, wherein the rotor core comprises a plurality of rotor sheets stacked in an axial direction.

6. The rotor according to claim 5, wherein the rotor comprises a rotor shaft connected to the rotor core by a shrink fit.

7. The rotor according to claim 1, wherein the skew portion is located closer to the inner portion of the rotor core than the outer portion of the rotor core.

8. (canceled)

9. (canceled)

10. (canceled)

11. (canceled)

12. The rotor according to claim 1, wherein the skew portion, the two outer branches and the outer portion of the rotor core define an outer intermediate cooling channel extending through the rotor core in an axial direction and being adapted for a flow of a cooling medium.

13. The rotor according to claim 1, wherein adjacent spokes define, together with the outer portion and the inner portion of the rotor core, an inner intermediate cooling channel extending through the rotor core in an axial direction and being adapted for a flow of a cooling medium.

14. (canceled)

15. An electric machine according to claim 16, wherein a nominal power of the electric machine is greater than or equal to 100 kW.

16. An electric machine comprising:
a stator; and
a rotor, the rotor comprising:
a rotor core having an outer portion and an inner portion located closer to the rotation axis of the rotor core than the outer portion, the outer portion being connected to the inner portion through a plurality of spokes, and the rotor core being adapted to be connected to a rotor shaft by a shrink fit, each of the spokes comprises at least one skew portion extending in a spoke angle relative to a radial direction of the rotor core, each of the spokes is connected to the outer portion of the rotor core through two outer branches, and to the inner portion of the rotor core through an inner branch, each of the spokes comprises a skew portion connected to the two outer branches and to the inner branch, wherein the outer branches are located at a distance from each other in a circumferential direction of the rotor core, the skew portion extends substantially in tangential direction, and each outer branch and inner branch extend substantially in radial direction, each of the spokes is symmetric with respect to a centre line of the inner branch, and the spokes are separate elements without contact with each other.

17. The rotor according to claim 2, wherein the rotor is a rotor for an induction machine.

18. The rotor according to claim 3, wherein the rotor is a rotor for an induction machine.

19. The rotor according to claim 2, wherein the rotor core comprises a plurality of rotor sheets stacked in an axial direction.

20. The rotor according to claim 3, wherein the rotor core comprises a plurality of rotor sheets stacked in an axial direction.

21. The rotor according to claim 19, wherein the rotor comprises a rotor shaft connected to the rotor core by a shrink fit.

22. The rotor according to claim 20, wherein the rotor comprises a rotor shaft connected to the rotor core by a shrink fit.

23. The rotor according to claim 2, wherein the skew portion, the two outer branches and the outer portion of the rotor core define an outer intermediate cooling channel extending through the rotor core in an axial direction and being adapted for a flow of a cooling medium.

24. The rotor according to claim 3, wherein the skew portion, the two outer branches and the outer portion of the rotor core define an outer intermediate cooling channel extending through the rotor core in an axial direction and being adapted for a flow of a cooling medium.

25. The rotor according to claim 2, wherein adjacent spokes define, together with the outer portion and the inner portion of the rotor core, an inner intermediate cooling channel extending through the rotor core in an axial direction and being adapted for a flow of a cooling medium.
